(19) United States
(12) Patent Application Publication
(10) Pub. No.: US 2010/0301197 A1
(43) Pub. Date: Dec. 2, 2010

(54) MONITORING SYSTEM

(75) Inventor: Paul Boyle, Cambridgeshire (GB)

Correspondence Address: EDWARDS ANGELL PALMER & DODGE LLP, P.O. BOX 55874, BOSTON, MA, 02205, US

(73) Assignee: Owlstone Limited, Cambridge (GB)

(21) Appl. No.: 12/531,378

(22) PCT Filed: Mar. 13, 2008
(86) PCT No.: PCT/GB2008/050176

§ 371 Date: Mar. 11, 2010

(30) Foreign Application Priority Data
Mar. 15, 2007 (GB) 0704968.7

(51) Int. Cl. H01J 49/26; G12B 13/00

(52) U.S. Cl. 250/252.1; 250/282; 250/281

(57) ABSTRACT

A system and method for monitoring user exposure to toxic compounds are described. Compounds monitored are preferable volatile organic compounds including benzene, toluene, or xylene. An adsorbent badge is provided for wearing by a user; this is subsequently analysed by means of a field asymmetric ion mobility spectrometer. Multiple badges may be provided to different users, each associated with a unique user identifier.

### FIELD OF THE INVENTION

The present invention relates to a system and method for monitoring user exposure to specific compounds; for example toxic, mutagenic or carcinogenic compounds, and in particular volatile organic compounds such as benzene.

### BACKGROUND OF THE INVENTION

Ion mobility spectrometry is a versatile technique used to detect presence of molecular species in a gas sample. The technique has particular application in detection of explosives, drugs, and chemical agents in a sample, although it is not limited to these applications. Portable detectors are commonly used for security screening, and in the defence industry.

Ion mobility spectrometry relies on the differential movement of different ion species through an electric field to a detector; by appropriate selection of the parameters of the electric field, ions having differing properties will reach the detector at differing times, if at all. Time of flight (TOF) ion mobility spectrometry measures the time taken by ions when subject to an electric field to travel along a drift tube to a detector against a drift gas flow. By varying the electric field ions of different characteristics will reach the detector at different times, and the composition of a sample can be analysed.

Field asymmetric ion mobility spectrometry (FAIMS) is a derivative of time of flight ion mobility spectrometry (TOFIMS). Background information relating to FAIMs can be found in L. A. Buryakov et al. Int. J. Mass. Spectrom. Ion Process. 128 (1993) 143; and E. V. Krylov et al. Int. J. Mass. Spectrom. Ion Process. 225 (2003) 39-51; hereby incorporated by reference.

Conventional FAIMS operates by drawing air at atmospheric pressure into a reaction region where the constituents of the sample are ionized. Chemical agents in vapour-phase compounds form ion clusters when they are exposed to their parent ions. The mobility of the ion clusters is mainly a function of shape and weight. The ions are blown between two metal electrodes, one with a low-voltage DC bias and the other with a periodic high-voltage pulse waveform, to a detector plate where they collide and a current is registered. Ions are quickly driven toward one electrode during the pulse phase and slowly driven toward the opposite electrode between pulses. Some ions impact an electrode before reaching the detector plate; other ions with the appropriate differential mobility reach the end, making this device a sort of differential mobility ion filter. A plot of the current generated versus DC bias provides a characteristic differential ion mobility spectrum. The intensity of the peaks in the spectrum, which corresponds to the amount of charge, indicates the relative concentration of the agent.

The present inventors have developed a modification of FAIMS, which does not require a drift gas flow for its operation. Instead, an electric field is used to cause ions to move toward the detector. This allows for a solid state construction which does not require a gas pump or similar, so allowing for greater miniaturisation of the device than would otherwise be possible, as well as a more robust construction. An ion filter is used which permits selected ion species to pass through the filter to the detector. The ion filter is tunable by varying the electric field applied thereto to allow different species to pass.

A spectrometer incorporating the ion filter is described in international patent application PCT/GB2005/050124, the contents of which are incorporated herein by reference. Briefly, the filter operates as follows. The filter structure comprises a plurality of ion channels formed by a pair of interdigitated structures. A plurality of electrodes are disposed proximate each ion channel, and in use the electrodes are controlled such that a first drive electric field is generated along the length of the ion channels, and a second transverse electric field is generated orthogonal to the first. The transverse field acts as a filter, driving ions of other than the selected mobility into the walls of the ion channel, while ions having the selected mobility are able to pass through the channels. In preferred embodiments the transverse field has an AC component and a DC component.

An alternative ion filter construction is described in international patent application WO2006/046077, the contents of which are incorporated herein by reference. The filter structure comprises a similar interdigitated structure defining a plurality of ion channels. The filter is formed of a plurality of conductive layers separated along the length of the channels by at least one non-conductive layer. By application of electric potential to the conductive layers, an electric field may be established within the ion channel. This electric field will affect the mobility of ions within the channel according to the nature of the field and the charge of the ions, and so can be used to selectively admit ions through the channel to the detector.

The ion filters and FAIMS devices described above allow for the construction of miniaturised, portable spectrometers, which can be used in the field and in a range of environments. In theory, they could be used for continuous, real-time monitoring of exposure to potentially hazardous substances, such as carcinogens and the like, by providing individuals with such a spectrometer. In practice, however, this would be costly, cumbersome, and unnecessary.

Generally, exposure to hazardous substances is of concern with regard to cumulative exposure over, say, a working shift or some other period of time. Real-time levels of exposure may vary widely, and it is not necessary to be aware of these as they happen. One carcinogen of particular concern in a range of industries is benzene, which is often present in fuels. There are currently legal exposure limits to benzene. It is often accompanied by other compounds such as toluene and xylene; these compounds are usually present at much higher concentrations than benzene and are significantly less dangerous (they typically have higher exposure limits). Existing technologies such as photo-ionisation-detectors (PID) detect the total amount of volatile organic compounds (VOCs), such as benzene, toluene, xylene etc. They are thus susceptible to false alarms as they are not selective between the compounds.

It may be possible to distinguish between benzene and other VOCs for calculation of exposure levels using conventional technology; however, this will require the samples to be sent offsite for detailed and costly analysis; the results of the analysis will often not be known for some time, and this can lead to greater potential exposure for users as the analysis results are awaited.

WO 2004/049384 describes a miniaturised ion mobility spectrometer, including a gas purification device formed from at least one adsorber material integrated inside a garment. DE 103 10 924 B3 describes a miniaturised ion mobility spectrometer for integration into a wearable garment.

US 2002/0007687 describes a rope-like collection structure used for detecting environmental properties which is laid out in a predetermined pattern, and subsequently analysed in a location-dependent manner to correlate analysis with physical location.

WO 01/008197 describes a micromechanical field asymmetric ion mobility filter and detection system.

US 2006/0286606 describes a test kit for detecting certain chemicals.

EP 0 447 158 describes an apparatus for detecting concealed explosives using an ion mobility spectrometer to analyse dust particles collected from clothing.

It would be beneficial for an alternative monitoring system to be developed.

### SUMMARY OF THE INVENTION

The FAIMS technology as described in our previous patent applications PCT/GB2005/050124 and PCT/GB2005/050126 can selectively distinguish between benzene and other VOCs; as well as being generally highly sensitive to specific compounds which may be difficult to monitor effectively using conventional technologies. This makes it possible to monitor exposure levels in places such as refineries and petrol forecourts, and to obtain accurate results without needing to send samples offsite for analysis. This enables employers to meet their health and safety obligations related to occupational exposure limits of benzene. We describe a low cost solution that enables employers to provide at risk personnel with a cost effective absorbent badge, which absorbs benzene over a period of time, which is then analysed with a FAIMS or alternative system.

Accordingly, a first aspect of the invention provides a method of monitoring exposure of a user to a substance, the method comprising:
providing the user with a wearable adsorbent article suitable for adsorbing and retaining the substance;
removing the article from the user, and coupling said article to an ion mobility spectrometer;
desorbing adsorbed substance from the wearable article, such that the substance enters the spectrometer; and
determining the amount of substance present in the spectrometer.

Thus, a user can be provided with an article, for example a badge or the like, which may be worn throughout a work shift or over a predetermined time period. The article will adsorb a desired substance, thereby being indicative of user exposure to that substance over the period during which the article is worn. An ion mobility spectrometer is then used to determine the amount of substance released from the article on desorption. The use of an ion mobility spectrometer, and preferably a portable ion mobility spectrometer, allows certain substances—for example, benzene, xylene, and toluene—to be distinguished without the need for offsite analysis. This further permits the use of adsorbent articles which do not themselves distinguish between these substances, so reducing the cost of providing the wearable articles.

Preferably at least one, and more preferably all, of the coupling, desorbing, and determining steps are carried out on site; that is, at generally the same location as the user. This need not be precisely the same location, but may be, for example, within the same factory or working area, or the like.

Preferably the ion mobility spectrometer is a field asymmetric ion mobility spectrometer; and more preferably a FAIMS device substantially as described in either or both of our previous patent applications PCT/GB2005/050124 and PCT/GB2005/050126. For example, the FAIMS device may be micro machined. The spectrometer may operate by the method comprising the steps of: ionising a sample to generate ions adjacent an ion channel, the ion channel being defined by a plurality of conductive layers separated along the length of the channel by at least one non-conductive layer; biasing the ions such that, in the absence of other forces, they would tend to travel along the ion channel; applying electric potential to the conductive layers, such that an electric field is established within the ion channel; and detecting generated ions which have passed through the ion channel.

The spectrometer itself may comprise an ionizer, an ion filter, and an ion detector; wherein the ion filter defines at least one ion channel along which ions may pass from the ionizer to the ion detector; and wherein the ion channel is defined by a plurality of conductive layers separated along the length of the channel by at least one non-conductive layer; the spectrometer further comprising control means for applying electric potential to the conductive layers of the ion channel.

Alternatively, the spectrometer may operate by the method of: providing a first drive electric field along the length of an ion channel; providing a second transverse electric field orthogonal to the first; ionising a sample to generate ions adjacent an entrance to the ion channel; and detecting generated ions which have passed through the ion channel. In this embodiment, the drive and transverse electric fields may be generated by a plurality of electrodes, each electrode contributing a component of both the drive and the transverse electric fields.

The spectrometer may comprise an ionizer, an ion filter, and an ion detector; wherein the ion filter defines at least one ion channel along which ions may pass from the ionizer to the ion detector; and wherein the ion filter comprises a plurality of electrodes disposed proximate the ion channel; the spectrometer further comprising electrode control means for controlling the electrodes such that a first drive electric field is generated along the length of the ion channel, and a second transverse electric field is generated orthogonal to the first, and wherein each of said plurality of electrodes is involved in generating a component of both the drive and transverse electric fields.

The ionisation step may comprise generating ions by means of UV exposure.

Other aspects of the construction of and method of operation of the spectrometer are found in PCT/GB2005/050124 and PCT/GB2005/050126, the contents of which are incorporated herein by reference.

The method may further comprise additional substance separation and/or analysis steps prior to entry of the substance into the spectrometer; for example, gas separation chromatography or the like may serve to increase resolution and sensitivity of the detection.

The method may further comprise the step of calculating the amount of substance which the user has been exposed to, based on the amount of substance present in the spectrometer. This may include comparing the detected amount of substance in the spectrometer with calibration data obtained from exposing the wearable article to a known amount of substance over a known time period. Multiple calibration points may be used.

The step of determining the amount of substance present in the spectrometer may further comprise distinguishing the substance from other substances present. The other substances may be similar or related substances (for example, VOCs), or may be dissimilar substances. Preferably the substance is a potentially hazardous substance, and the other substances are at least less potentially hazardous (for example, having higher recommended limits on exposure), or more preferably are considered generally non-hazardous.

Preferably the substance is a potentially hazardous substance; for example a potential toxin, a potential carcinogen, a potential mutagen, or the like. The substance may in preferred embodiments be a volatile organic compound (VOC), and preferably is benzene.

Preferably the method comprises providing a plurality of users with wearable adsorbent articles. Each user may be separately monitored; this allows many users to be monitored with one or a few spectrometers. The method may further comprise identifying each user with a unique identity, and associating the determined amount of substance with that identity. (By ‘unique’ is meant that the identity is at least distinct from other identities in use among the plurality of users; it need not be absolutely unique, although in certain embodiments it may be). The user may be identified by means of an identity associated with each wearable article; the method may further comprise the step of inputting the identity details to a controller controlling the spectrometer; for example, an electronic computer, or other processing device. The identity details may be input manually by an operator, or may be automatically read by the controller. For example, each wearable article may bear a bar code or other machine readable identifier which may be read by the controller in order to input the identity. Alternatively the machine readable identifier may be a RFID device or the like.

The method may further comprise the step of recording the amount of substance present in the spectrometer; and/or recording the calculated exposure of the user to the substance. A log of recorded data may be kept, to monitor a user's exposure over a longer time period than the wearable article has been worn for.

The wearable article may be in the form of a badge or similar. The article is preferably a passive adsorbing article; for example, a passive ‘OVM’ (organic vapour monitor') device.

The step of desorbing adsorbed substance from the article may comprise treating the article in order to desorb substance; preferably this comprises heating the article. In other embodiments, chemical desorbtion may be used, whereby the analyte is dissolved in a solvent prior to analysis. The desorbing may be selective, in that only a specific desired substance is desorbed, while other substances are not desorbed, but in preferred embodiments the desorbing is not selective. The spectrometer may be used to distinguish between different substances, thereby reducing the cost of providing the adsorbent article.

In certain embodiments, the wearable article may selectively adsorb the substance, or may selectively adsorb the substance and one or more other substances.

A further aspect of the invention provides a method of monitoring exposure of a volume to a substance, the method comprising:
providing the volume with an adsorbent article suitable for adsorbing and retaining the substance;
removing the article from the volume, and coupling said article to an ion mobility spectrometer;
desorbing adsorbed substance from the article, such that the substance enters the spectrometer; and
determining the amount of substance present in the spectrometer.

This embodiment allows the technology to be used for monitoring the environmental conditions within a volume; for example, within a workplace. While less informative than monitoring individual users, this may nonetheless be the preferred method in certain situations.

A further aspect of the present invention provides a kit for monitoring exposure of a user to a substance, the kit comprising:
one or more wearable adsorbent articles suitable for adsorbing and retaining the substance; and
an ion mobility spectrometer.

The kit may also comprise instructions for use of the spectrometer and/or the wearable articles. The wearable article may be in the form of a badge; and may comprise activated charcoal, PDMS, or any other suitable material.

The spectrometer may comprise an ionizer, an ion filter, and an ion detector;
wherein the ion filter defines at least one ion channel along which ions may pass from the ionizer to the ion detector; and
wherein the ion channel is defined by a plurality of conductive layers separated along the length of the channel by at least one non-conductive layer;
the spectrometer further comprising control means for applying electric potential to the conductive layers of the ion channel.

Alternatively, the spectrometer may comprise an ionizer, an ion filter, and an ion detector;
wherein the ion filter defines at least one ion channel along which ions may pass from the ionizer to the ion detector; and
wherein the ion filter comprises a plurality of electrodes disposed proximate the ion channel;
the spectrometer further comprising electrode control means for controlling the electrodes such that a first drive electric field is generated along the length of the ion channel, and a second transverse electric field is generated orthogonal to the first, and wherein each of said plurality of electrodes is involved in generating a component of both the drive and transverse electric fields.

Aspects of the invention further provide a kit for monitoring exposure of a user to a substance, the kit comprising one or more wearable adsorbent articles suitable for adsorbing and retaining the substance; and instructions for use of the adsorbent article with an ion mobility spectrometer.

### BRIEF DESCRIPTION OF THE DRAWINGS

These and other aspects of the present invention will now be described by way of example only and with reference to the accompanying drawings in which:

FIG. 1 shows a schematic diagram of an embodiment of the present invention; and

FIGS. 2 to 4 show representative results demonstrating the detection of benzene using the FAIMS device as used in embodiments of the present invention.

### DETAILED DESCRIPTION OF THE DRAWINGS

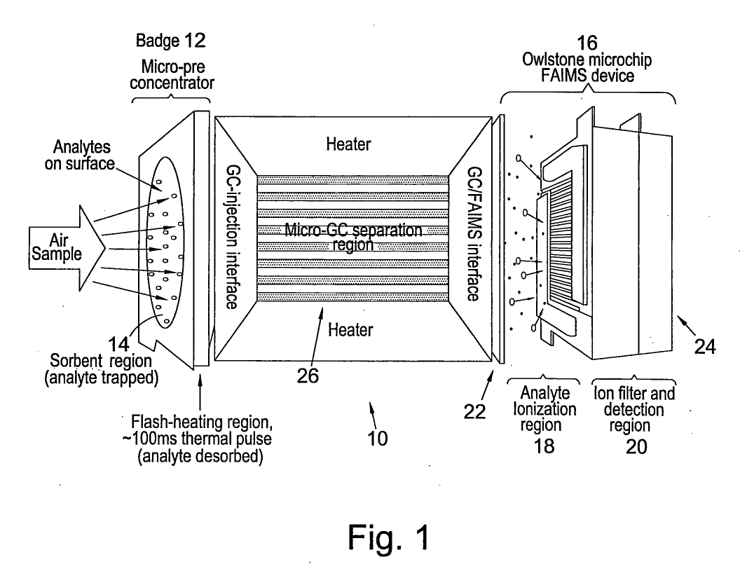

Referring first of all to FIG. 1, this shows a system 10 for use in monitoring user exposure to a substance, for example a potentially carcinogenic substance such as benzene. The system. 10 includes a wearable badge 12, which includes an adsorbent pad 14 (for example, including activated charcoal, PDMS, or another suitable material); and a FAIMS device 16. The FAIMS device 16 is substantially as described in our international patent application WO 2006/013396. The device 16 is a microminiaturised FAIMS device which includes an ioniser 18, an ion filter 20 comprising a plurality of ion channels including electrodes disposed proximate the ion channel, which in use are controlled such that a first drive electric field is generated along the length of the ion channel, and a second transverse electric field is generated orthogonal to the first. In this embodiment the FAIMS device 16 also includes a separate deflector electrode 22 and a detection electrode 24; together with appropriate control electronics (not shown) for driving the various electrodes as appropriate, and for detecting ions which pass through the filter. Further details of the operation of the FAIMS device may be found in the abovementioned international patent application. The system also includes a gas chromatography separation device 26 (shown schematically), interposed between the badge 12 and the FAIMS device 16. The purpose of this device is simply to enhance separation between different substances in this particular embodiment; it is not an essential component of the invention, but is optional.

The operation of the system is as follows. A user wears the badge 12 over a period of time (for example, during a work shift or the like) for which their exposure to a potential carcinogen such as benzene is desired to be determined. As the badge 12 is exposed to the environment within which the user is, the pad 14 adsorbs a range of compounds to which the user is exposed. At the end of the work shift, the user removes the badge 12, and it is connected to the input of the gas chromatography separation device 26. The badge 12 is flash-heated with a thermal pulse lasting c. 100 ms, which causes analyte to be desorbed from the pad 14, and enter the gas chromatography device 26. Here the various compounds released from the badge are separated (to allow for increased resolution of different compounds within the FAIMS device), from where they then pass into the FAIMS device 16. By appropriate tuning of the ion filter, preselected compounds will be permitted to pass through the ion filter to the ion detection region. It is at this stage where selectivity of the detected compound is found; the previous stages in the method are generally unselective; it is thus relatively straightforward to modify the ion filter operation so as to pass a different selected compound if this is desired.

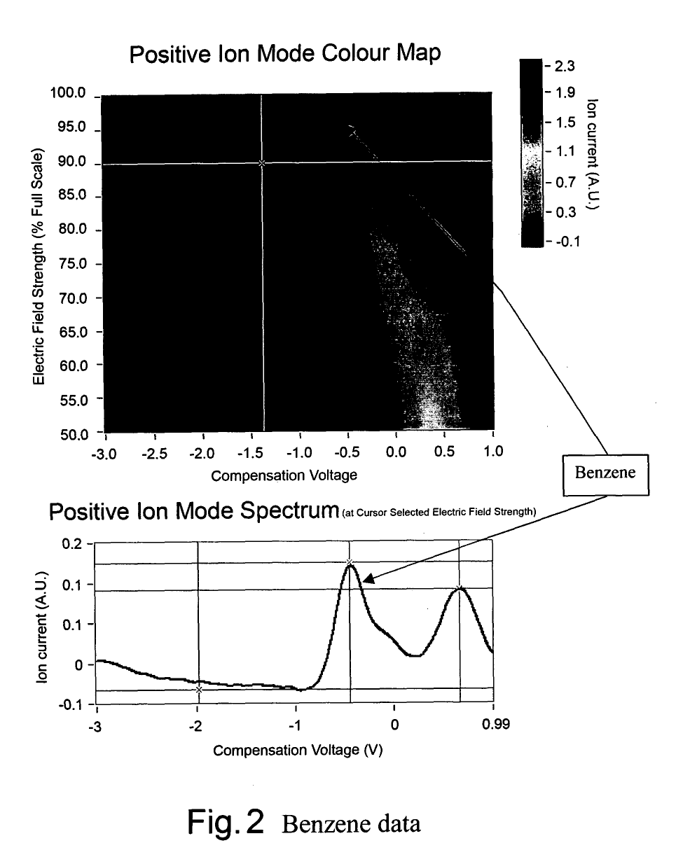

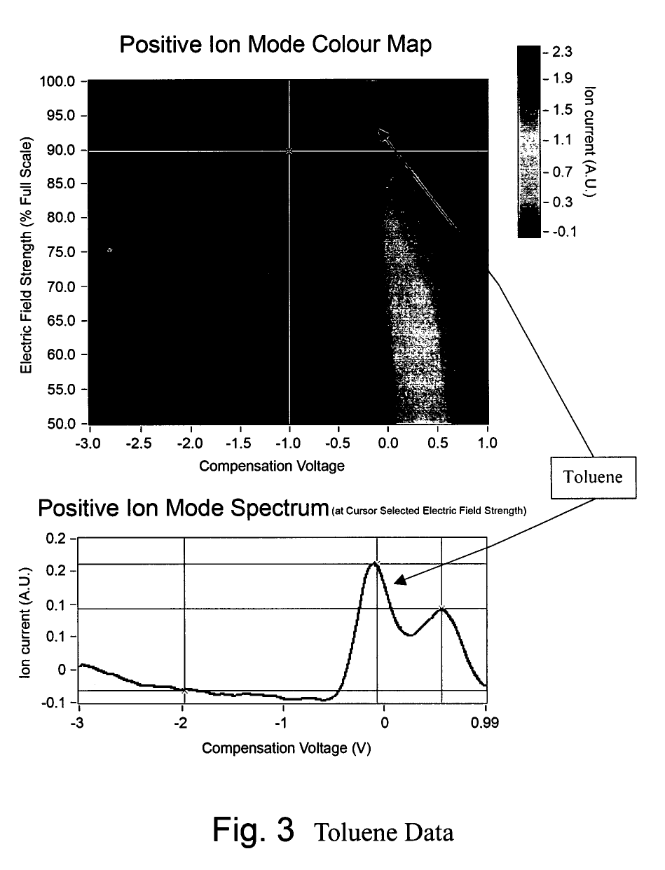

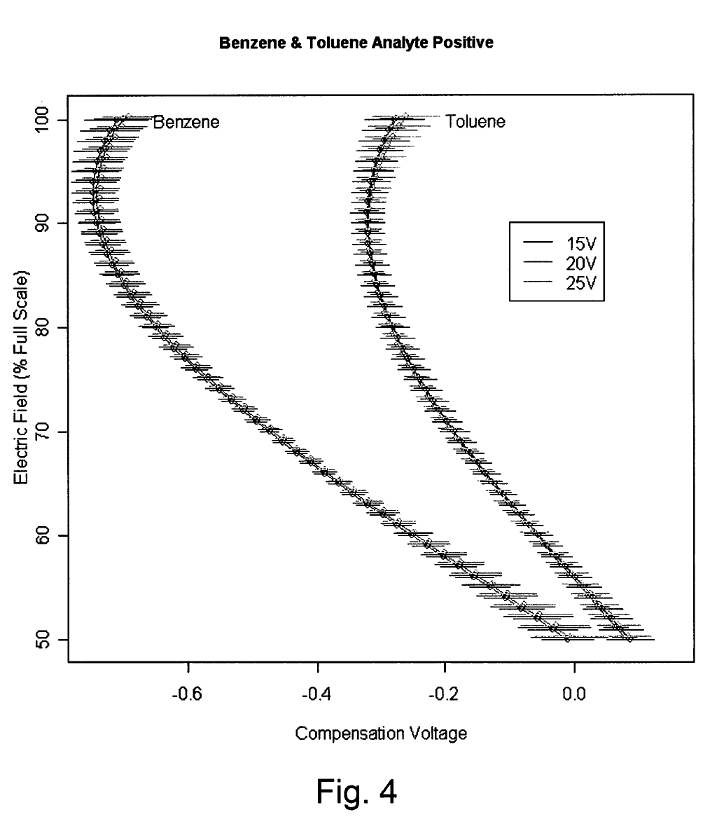

Unlike prior art detection and monitoring systems, the present invention allows discrimination of otherwise similar compounds without the need for complex offsite analysis. In preferred embodiments, the FAIMS device 16 is kept onsite, at the same location or within the same complex as the users and badges 12. This arrangement is sufficient to allow rapid detection of benzene exposure, and discrimination of benzene from otherwise similar VOCs such as toluene. As an example of this, FIGS. 2 to 4 show the effective detection and discrimination of benzene from other VOCs using a FAIMS device substantially as described. FIG. 2 shows detection of benzene alone; FIG. 3 shows detection of toluene alone; while FIG. 4 shows the clear distinction between toluene and benzene made using the PAWS device. The results shown are obtained using a radioactive ionisation source; in alternative embodiments other ionisation sources may be used, for example a 10.6 eV UV ionisation source. This improves selectivity, and removes the need for the regulatory burden of using radioactive sources.

Once benzene or another desired compound is detected using the system, the overall levels of benzene released from the badge can be determined. This information itself can be the final output from the system, but it is more preferable if this is used to determine the actual exposure of the user to the compound; for example, by comparison of the detected levels with calibration data showing detected levels from a range of known exposures. This result can be logged, and used to monitor exposure over several time periods. In preferred embodiments, a number of users are provided with badges, and each user's exposure is monitored. Each user may be associated with a specific identifier; for example, a bar code or other identifier recorded on the badge, or an RFID tag attached to each badge and detected by the FAIMS device or controller thereof.

The present invention has a number of clear advantages over the prior art systems. The individual badge is very low cost as it consists of a holder and absorbent material. This makes it very cost effective to equip an entire workforce. In addition the analysis time is fast, which yields a total monitoring solution with a low initial capital outlay and minimised operating costs. The use of a portable FAIMS device allows analysis to be made on site instead of having to bring samples back to a lab for analysis. The FAIMS sensor can analyse samples within seconds as opposed to a laboratory gas chromatography/mass spectrometry analysis, which takes tens of minutes. The adsorbent material of the badge effectively preconcentrates benzene over a long period of time to provide better sensitivity and lower detection limits. The adsorbent material in preferred embodiments only retains compounds of interest, thus providing preseparation, which results in better selectivity and lower false positives. The system is also robust against environmental variation; FAIMS systems drift with changes in environmental variables such as humidity and temperature. The absorbent material is hydrophilic and will be immune to humidity change. The desorbed vapours are introduced into a well controlled, clean air inlet, which removes the potential for device drift, and misidentification. The absorbent badge is a very small and light weight unit, which means it is unobtrusive to use and does not interfere with normal working practices. The absorbent badge is passive and doesn't require power. The analysis unit is connected to mains so power consumption is not an issue. Finally, less expertise is required for the system's operation, as the analysis can be carried out by an non-expert as opposed to analysis in a laboratory which requires extensive training.

1. A method of monitoring exposure of a user to a substance, the method comprising:
providing the user with a wearable adsorbent article suitable for adsorbing and retaining the substance;
removing the article from the user, and coupling said article to an ion mobility spectrometer;
desorbing adsorbed substance from the wearable article, such that the substance enters the spectrometer; and
determining the amount of substance present in the spectrometer.

2. The method of claim 1, wherein at least one, and more preferably all, of the coupling, desorbing, and determining steps are carried out on site.

3. The method of claim 1, wherein the ion mobility spectrometer is a field asymmetric ion mobility spectrometer.

4. The method of claim 1, wherein the ion mobility spectrometer is micromachined.

5. The method of claim 1, wherein the spectrometer operates by a method comprising the steps of: ionising a sample to generate ions adjacent an ion channel, the ion channel being defined by a plurality of conductive layers separated along the length of the channel by at least one nonconductive layer; biasing the ions such that, in the absence of other forces, they would tend to travel along the ion channel; applying electric potential to the conductive layers, such that an electric field is established within the ion channel; and detecting generated ions which have passed through the ion channel.

6. The method of claim 1, wherein the spectrometer operates by a method of: providing a first drive electric field along the length of an ion channel; providing a second transverse electric field orthogonal to the first; ionising a sample to generate ions adjacent an entrance to the ion channel; and detecting generated ions which have passed through the ion channel.

7. The method of claim 6, wherein the drive and transverse electric fields are generated by a plurality of electrodes, each electrode contributing a component of both the drive and the transverse electric fields.

8. The method of claims 5, wherein the ionisation step comprises generating ions by means of UV exposure.

9. The method of claim 1, further comprising additional substance separation and/or analysis steps prior to entry of the substance into the spectrometer.

10. The method of claim 1, further comprising the step of calculating the amount of substance which the user has been exposed to, based on the amount of substance present in the spectrometer.

11. The method of claim 10, wherein the calculating step comprises comparing the detected amount of substance in the spectrometer with calibration data obtained from exposing the wearable article to a known amount of substance over a known time period.

12. The method of claim 1, wherein the step of determining the amount of substance present in the spectrometer further comprises distinguishing the substance from other substances present.

13. The method of claim 1, wherein the substance is benzene.

14. The method of claim 1, comprising providing a plurality of users with wearable adsorbent articles.

15. The method of claim 14 further comprising identifying each user with a unique identity, and associating the determined amount of substance with that identity.

16. The method of claim 15 wherein the user is identified by means of an identity associated with each wearable article.

17. The method of claim 1, further comprising the step of recording the amount of substance present in the spectrometer; and/or recording the calculated exposure of the user to the substance.

18. The method of claim 1, wherein the wearable article is in the form of a badge or similar.

19. The method of claim 1, wherein the wearable article comprises a passive adsorbing article.

20. The method of claim 1, wherein the step of desorbing adsorbed substance from the article comprises treating the article in order to desorb substance; preferably this comprises heating the article.

21. A method of monitoring exposure of a volume to a substance, the method comprising:
providing the volume with an adsorbent article suitable for adsorbing and retaining the substance;
removing the article from the volume, and coupling said article to an ion mobility spectrometer;
desorbing adsorbed substance from the article, such that the substance enters the spectrometer; and
determining the amount of substance present in the spectrometer.

22. A kit for monitoring exposure of a user to a substance, the kit comprising:
one or more wearable adsorbent articles suitable for adsorbing and retaining the substance; and
an ion mobility spectrometer.

23. The kit of claim 22 further comprising instructions for use of the spectrometer and/or the wearable articles.

24. The kit of claim 21 or 22 wherein the spectrometer comprises an ionizer, an ion filter, and an ion detector;
wherein the ion filter defines at least one ion channel along which ions may pass from the ionizer to the ion detector; and
wherein the ion filter comprises a plurality of electrodes disposed proximate the ion channel;
the spectrometer further comprising electrode control means for controlling the electrodes such that a first drive electric field is generated along the length of the ion channel, and a second transverse electric field is generated orthogonal to the first, and wherein each of said plurality of electrodes is involved in generating a component of both the drive and transverse electric fields.

25. A kit for monitoring exposure of a user to a substance, the kit comprising one or more wearable adsorbent articles suitable for adsorbing and retaining the substance; and instructions for use of the adsorbent article with an ion mobility spectrometer.
